(19) United States
(12) Patent Application Publication
(10) Pub. No.: US 2020/0215785 A1
(43) Pub. Date: Jul. 9, 2020

(54) ANISOTROPIC CONDUCTIVE FILM

(71) Applicant: DEXERIALS CORPORATION, Tokyo (JP)

(72) Inventors: Taichiro KAJITANI, Yuki-shi (JP); Reiji TSUKAO, Utsunomiya-shi (JP)

(73) Assignee: DEXERIALS CORPORATION, Tokyo (JP)

(21) Appl. No.: 16/640,461

(22) PCT Filed: Jul. 31, 2018
(86) PCT No.: PCT/JP2018/028623

§ 371 Date: Feb. 20, 2020

(30) Foreign Application Priority Data
Aug. 23, 2017 (JP) 2017-160630

(51) Int. Cl. B32B 3/26; B32B 3/30; B32B 27/18; B32B 7/12; B32B 27/38; B32B 27/30; B32B 5/16; H01R 43/02; H01R 11/01

(52) U.S. Cl. CPC B32B 3/263; B32B 38/0008; B32B 27/18; B32B 7/12; B32B 27/38; B32B 27/308; B32B 5/16; H01R 43/02; H01R 11/01; B32B 2307/202; B32B 2307/206; B32B 2260/04; B32B 2310/08; B32B 2457/04; B32B 3/30

(57) ABSTRACT

An anisotropic conductive film configured to suppress flowing of conductive particles attributable to the flowing of an insulating resin layer at the time of anisotropic conductive connection, improve the conductive particle capturing properties, and reduce short circuits has a conductive particle dispersion layer including the conductive particles dispersed (or distributed) in the insulating resin layer. The insulating resin layer is a layer of a photo-polymerizable resin composition. The surface of the insulating resin layer in the vicinity of each of the conductive particles has an inclination or an undulation with respect to the tangent plane of the insulating resin layer in the center portion between the adjacent conductive particles.

### TECHNICAL FIELD

The present invention relates to an anisotropic conductive film.

### BACKGROUND ART

An anisotropic conductive film obtained by dispersing conductive particles in an insulating resin layer is widely used for mounting an electronic component such as an IC chip. In an anisotropic conductive film, conductive particles are usually dispersed in an insulating resin layer with high density for achieving high mounting density. However, increasing the number density of conductive particles leads to the occurrence of short circuits.

To cope with this matter, an anisotropic conductive film obtained by laminating a photo-polymerizable resin layer including a single layer of embedded conductive particles to an insulating adhesive layer has been proposed (Patent Literature 1), for the purpose of reducing short circuits and improving workability when temporarily pressure-bonding an anisotropic conductive film to a substrate. This anisotropic conductive film is used by temporarily pressure-bonding the film to a substrate in a state where a photo-polymerizable resin layer is not polymerized and has tack properties, subsequently photo-polymerizing the photo-polymerizable resin layer to immobilize conductive particles, and thereafter permanently pressure-bonding the substrate and an electronic component.

Also, an anisotropic conductive film having a three-layer structure in which a first connection layer is held between a second connection layer and a third connection layer both mainly formed of an insulating resin (Patent Literatures 2 and 3) has been proposed, in order to achieve the same purpose as that disclosed in Patent Literature 1. Specifically, in the anisotropic conductive film of Patent Literature 2, the first connection layer has a structure in which conductive particles are arranged in a single layer in a plane direction of an insulating resin layer on the side of the second connection layer, and the insulating resin layer in a central region between adjacent conductive particles is thinner than the insulating resin layer in the vicinity of the conductive particles. On the other hand, in the anisotropic conductive film of Patent Literature 3, undulations exist at a boundary between the first connection layer and the third connection layer, the first connection layer has a structure in which conductive particles are arranged in a single layer in a plane direction of an insulating resin layer on the side of the third connection layer, and the insulating resin layer in a central region between adjacent conductive particles is thinner than the insulating resin layer in the vicinity of the conductive particles.

### CITATION LIST

### Patent Literature

Patent Literature 1: Japanese Patent Application Laid-Open No. 2003-64324

Patent Literature 2: Japanese Patent Application Laid-Open No. 2014-060150

Patent Literature 3: Japanese Patent Application Laid-Open No. 2014-060151

### SUMMARY OF INVENTION

### Technical Problem

However, the anisotropic conductive film described in Patent Literature 1 has a problem in that the conductive particles are easily moved at the time of temporary pressure-bonding by anisotropic conductive connection, with the result that precise disposition of the conductive particles before anisotropic conductive connection cannot be maintained after the connection, or the conductive particles cannot be sufficiently spaced apart from each other. Also, when the photo-polymerizable resin layer is photo-polymerized after such an anisotropic conductive film has been temporarily pressure bonded to a substrate and an electronic component is bonded to the photo-polymerized resin layer in which the conductive particles are embedded, a problem has been raised in that the conductive particles are less likely to be captured at the end of a bump of the electronic component, and excessively large force is required for pushing the conductive particles resulting in failing to sufficiently push the conductive particles. Also, in Patent Literature 1, studies from the viewpoint of the exposure of the conductive particles or the like on the photo-polymerizable resin layer for solving the problem regarding the pushing of the conductive particles are not sufficiently conducted.

To address these concerns, it is conceivable to disperse conductive particles in a thermo-polymerizable insulating resin layer, which becomes high in viscosity at the heating temperature at the time of anisotropic conductive connection, in place of the photo-polymerizable resin layer, for suppressing the flowing property of the conductive particles at the time of anisotropic conductive connection, as well as for improving workability when bonding the anisotropic conductive film to an electronic component. However, even if conductive particles are precisely disposed in such an insulating resin layer, the conductive particles flow simultaneously when the resin layer flows at the time of anisotropic conductive connection. Therefore, it is difficult to sufficiently improve the conductive particle capturing properties and reduce short circuits. Furthermore, it is also difficult to maintain the initial precise disposition of conductive particles after anisotropic conductive connection, and to retain the conductive particles in a state in which conductive particles are spaced apart from each other. Thus, under the current state, it is desired to disperse and retain conductive particles in a photo-polymerizable resin layer.

In the anisotropic conductive film having a three-layer structure described in Patent Literatures 2 and 3, a problem is not raised regarding fundamental anisotropic conductive connection properties, but production man-hours are required to be reduced from the viewpoint of production costs, because of its three-layer structure. Also, since the entirety or a portion of the first connection layer has a swelling portion which is larger than the outer shape of the conductive particle (the insulating resin layer itself becomes non-flat) in the vicinity of the conductive particle on one surface of the first connection layer, and the conductive particle is retained in the swelling portion, there is a concern that design restrictions are likely to increase in order to balance between retaining and immobilizing the conductive particles and facilitating holding by terminals.

Under such circumstances, a problem to be solved by the present invention is to provide an anisotropic conductive film including conductive particles dispersed (or distributed) in a photo-polymerizable insulating resin layer, the anisotropic conductive film being configured to suppress unnecessary movement (flowing) of the conductive particles attributable to the flowing of the photo-polymerizable insulating resin layer at the time of anisotropic conductive connection, improve the conductive particle capturing properties, and reduce short circuits, even when a three-layer structure is not a prerequisite, and the entirety or a portion of the photo-polymerizable insulating resin layer does not have a swelling portion which is larger than the outer shape of the conductive particle in the vicinity of the conductive particle in the photo-polymerizable insulating resin layer that retains the conductive particles.

### Solution to Problem

When providing a conductive particle dispersion layer in which conductive particles are dispersed (or distributed) in a photo-polymerizable insulating resin layer to an anisotropic conductive film, the present inventor has found the following knowledge (i) and (ii) about a surface shape in the vicinity of a conductive particle in the photo-polymerizable insulating resin layer, and the following knowledge (iii) about a timing for photo-polymerizing the photo-polymerizable insulating resin layer.

That is, while the surface of the photo-polymerizable insulating resin layer itself on the side where the conductive particles are embedded is flat in the anisotropic conductive film according to Patent Literature 1, the present inventor has found that: (i) when the conductive particles are exposed from the photo-polymerizable insulating resin layer, if the surface of the photo-polymerizable insulating resin layer around each of the conductive particles inclines toward the inside of the photo-polymerizable insulating resin layer with respect to the tangent plane of the photo-polymerizable insulating resin layer in the center portion between the adjacent conductive particles, the surface of the insulating resin layer loses flatness and becomes partly chipped (the surface of the photo-polymerizable insulating resin layer becomes partly chipped, leading to a state in which the flatness of the surface of the linear insulating resin layer is partly lost), with the result that unnecessary insulating resin which may prevent the conductive particle from being held between terminals at the time of anisotropic conductive connection or from being flattened; and (ii) when the conductive particles are embedded in the photo-polymerizable insulating resin layer without being exposed from the insulating resin layer, if the insulating resin layer right above each of the conductive particles has a wave, that is, a minute undulation to serve as a trace (hereinafter, merely described as an undulation), with respect to the tangent plane of the insulating resin layer in the center portion between the adjacent conductive particles, the conductive particle becomes easy to be pushed by a terminal at the time of anisotropic conductive connection, the conductive particle capturing properties at a terminal improve, and the product testing of the anisotropic conductive film and the recognition of a used surface are facilitated. Furthermore, the present inventor has found that such an inclination or undulation in the photo-polymerizable insulating resin layer can be formed by adjusting the viscosity of the insulating resin layer, the pushing speed, the temperature, and the like when pushing the conductive particle in forming a conductive particle dispersion layer by pushing the conductive particles into the insulating resin layer.

The present inventor has further found that: (iii) when a connection structure is produced by bonding electronic components by anisotropic conductive connection with an anisotropic conductive film like that according to the present invention, if the photo-polymerizable insulating resin layer of the anisotropic conductive film is irradiated with light after the anisotropic conductive film has been disposed on one of the electronic components and before the other electronic component is disposed thereon, the minimum melt viscosity of the insulating resin at the time of anisotropic conductive connection can be prevented from excessively decreasing, and the conductive particles can be prevented from unnecessarily flowing, with the result that the connection structure has favorable conduction characteristics.

The present invention provides an anisotropic conductive film having a conductive particle dispersion layer including conductive particles dispersed (or distributed) in an insulating resin layer, wherein the insulating resin layer is a layer of a photo-polymerizable resin composition, and the surface of the insulating resin layer in the vicinity of each of the conductive particles has an inclination or an undulation with respect to the tangent plane of the insulating resin layer in the center portion between the adjacent conductive particles.

In the anisotropic conductive film according to the present invention, it is preferable that in the inclination, the surface of the insulating resin layer around each of the conductive particles be lacked with respect to the tangent plane, and in the undulation, the resin amount of the insulating resin layer right above the conductive particle be smaller than that when the surface of the insulating resin layer right above the conductive particle is flush with the tangent plane. Alternatively, it is preferable that a ratio (Lb/D) of a distance Lb from the tangent plane to the deepest portion of the conductive particle to a conductive particle diameter D be 30% or more and 105% or less.

The photo-polymerizable resin composition may be photocationic-polymerizable, photoanionic-polymerizable, or photoradical-polymerizable, but is preferably a photocationic-polymerizable resin composition which contains a polymer for forming a film, a photocationic-polymerizable compound, a photo-cationic polymerization initiator, and a thermo-cationic polymerization initiator. Here, a preferable photocationic-polymerizable compound is at least one selected from an epoxy compound and an oxetane compound, and a preferable photo-cationic polymerization initiator is aromatic onium-tetrakis(pentafluorophenyl)borate. Also, when the photo-polymerizable resin composition is a photoradical-polymerizable resin composition, the composition preferably contains a polymer for forming a film, a photoradical-polymerizable compound, a photo-radical polymerization initiator, and a thermo-radical polymerization initiator.

In the anisotropic conductive film according to the present invention, the surface of the insulating resin layer around the conductive particle exposed from the insulating resin layer may have an inclination or an undulation, or the surface of the insulating resin layer right above the conductive particle embedded in the insulating resin layer without being exposed from the insulating resin layer may have an inclination or an undulation. A ratio (La/D) of a layer thickness La of the insulating resin layer to a conductive particle diameter D is preferably 0.6 to 10, and the conductive particles are preferably disposed without being in contact with each other. The closest distance between the conductive particles is preferably 0.5 times or more and 4 times or less the conductive particle diameter.

In the anisotropic conductive film according to the present invention, a second insulating resin layer may be laminated to a surface opposite to the surface having the inclination or the undulation of the insulating resin layer. Alternatively, the second insulating resin layer may be laminated to the surface having the inclination or the undulation of the insulating resin layer. In either case, the minimum melt viscosity of the second insulating resin layer is preferably lower than that of the insulating resin layer. It is noted that the CV value of the particle diameter of the conductive particles is preferably 20% or less.

The anisotropic conductive film according to the present invention can be produced by a producing method including a step of forming a conductive particle dispersion layer containing conductive particles dispersed (or distributed) in an insulating resin layer. Here, the step of forming a conductive particle dispersion layer includes: a step of retaining the conductive particles in a state of being dispersed (or distributed) on a surface of an insulating resin layer formed of a photo-polymerizable resin composition; and a step of pushing, into the insulating resin layer, the conductive particles retained on the surface of the insulating resin layer. In the step of pushing the conductive particles into the surface of the insulating resin layer, the viscosity of the insulating resin layer, the pushing speed, or the temperature when the conductive particles are pushed is adjusted such that the surface of the insulating resin layer in the vicinity of each of the conductive particles has an inclination or an undulation with respect to the tangent plane of the insulating resin layer in the center portion between the adjacent conductive particles. More particularly, the step of pushing the conductive particles into the insulating resin layer is preferably performed such that in the inclination, the surface of the insulating resin layer around each of the conductive particles is lacked with respect to the tangent plane, and in the undulation, the resin amount of the insulating resin layer right above the conductive particle is smaller than that when the surface of the insulating resin layer right above the conductive particle is flush with the tangent plane. Alternatively, the ratio (Lb/D) of the distance Lb from the tangent plane to the deepest portion of the conductive particle to the conductive particle diameter D is 30% or more and 105% or less. Within this value range, the ratio of not less than 30% and less than 60% allows the conductive particle to be retained to a minimum, and facilitates mounting at low temperature and low pressure because exposure of the conductive particle from the resin layer is large. The ratio of 60% or more and 105% or less allows the conductive particle to be more easily retained, and is likely to maintain the state of the conductive particle to be captured before and after connection.

It is noted that the photo-polymerizable resin composition and the CV value of the particle diameter of the conductive particles are as described above.

In the method of producing the anisotropic conductive film according to the present invention, it is preferable that the conductive particles be retained in a predetermined arrangement on the surface of the photo-polymerizable insulating resin layer in the step of retaining the conductive particles on the surface of the insulating resin layer, and the conductive particles be pushed into the photo-polymerizable insulating resin layer using a flat plate or a roller in the step of pushing the conductive particles into the insulating resin layer. In the step of retaining the conductive particles on the surface of the insulating resin layer, it is preferable that a transfer mold be filled with the conductive particles, and the conductive particles be transferred to the photo-polymerizable insulating resin layer, thereby to retain the conductive particles in a predetermined disposition on the surface of the insulating resin layer.

The present invention further provides a connection structure in which a first electronic component and a second electronic component are bonded by anisotropic conductive connection with the above-described anisotropic conductive film.

The connection structure according to the present invention can be produced by a producing method which includes: an anisotropic conductive film disposition step of disposing the anisotropic conductive film to a first electronic component on a side having an inclination or an undulation of the conductive particle dispersion layer or on a side not having an inclination or an undulation; a light irradiation step of performing light irradiation on the anisotropic conductive film either on a side of the anisotropic conductive film or on a side of the first electronic component to photo-polymerize the conductive particle dispersion layer; and a thermal pressure-bonding step of disposing a second electronic component on the photo-polymerized conductive particle dispersion layer, and heating and pressurizing the second electronic component with a thermal pressure bonding tool to bond the first electronic component and the second electronic component by anisotropic conductive connection. It is preferable that the anisotropic conductive film be disposed to the first electronic component on a side of having the inclination or the undulation of the conductive particle dispersion layer in the disposition step, and light irradiation be performed on the side of the anisotropic conductive film in the light irradiation step.

### Advantageous Effects of Invention

The anisotropic conductive film according to the present invention has a conductive particle dispersion layer including conductive particles dispersed (or distributed) in a photo-polymerizable insulating resin layer. In this anisotropic conductive film, the surface of the insulating resin layer in the vicinity of each of the conductive particles has an inclination or an undulation with respect to the tangent plane of the insulating resin layer in the center portion between the adjacent conductive particles. That is, when the conductive particle is exposed from the photo-polymerizable insulating resin layer, the insulating resin layer around the exposed conductive particle has an inclination. When the conductive particle is embedded in the photo-polymerizable insulating resin layer without being exposed from the insulating resin layer, the insulating resin layer right above the conductive particle has an undulation, or the conductive particle is in contact with the insulating resin layer at one point.

In other words, since the conductive particle is embedded in the photo-polymerizable insulating resin in the anisotropic conductive film according to the present invention, the following cases can be present in the vicinity of the conductive particle depending on an embedded degree: a case in which the resin exists along the outer circumference of the conductive particle (for example, see FIG. 4 and FIG. 6); and a case in which the insulating resin tends to be flat as a whole, but is dragged by the embedding of the conductive particle and accordingly enters the inside (for example, see FIG. 1B and FIG. 2). The case in which the resin enters the inside includes a state like a cliff caused by the embedding of the conductive particle into the resin (FIG. 3). Both cases can co-exist. As described herein, the inclination indicates an inclined surface formed when the insulating resin is dragged by the embedding of the conductive particle and accordingly enters the inside, and the undulation indicates such an inclination and the insulating resin layer which is deposited onto the conductive particle subsequently to the inclination (the inclination may disappear due to deposition). Since the formation of an inclination or an undulation in the insulating resin allows the conductive particle to be retained in a state of being partly or entirely embedded in the insulating resin, effects such as the flowing of the resin at the time of connection can be minimized, which improves the conductive particle capturing properties at the time of connection. Since the insulating resin amount in the vicinity of the conductive particle in at least part of the film surface to be connected to a terminal is smaller than those in Patent Literatures 2 and 3 (the insulating resin amount in the thickness direction of the conductive particle decreases), the terminal and the conductive particle are easily brought into direct contact with each other. That is, the resin, which may prevent the conductive particle from being pushed at the time of connection, does not exist or decreases, resulting in a minimized resin amount. Furthermore, the insulating resin, for example, lacks a surface which roughly follows the outer shape of the conductive particle, but is less likely to have excessive swelling. In this case, the resin becomes easily relatively high in viscosity so that the conductive particle can be retained, and the resin amount on a film surface to become a connection surface connected to a terminal, in particular, right above the conductive particle is preferably small. Alternatively, it is also preferable that a relatively high viscosity resin, which retains the conductive particle along the outer shape of the conductive particle, do not exist, for the same reason as above. In this manner, the present invention comes to conform to these configurations. It is noted that since the resin follows the outer shape of the conductive particle, effects by pushing are expected to be easily expressed, and the effect of facilitating quality determination by external observation in the production of the anisotropic conductive film is also expected. Furthermore, since a terminal and the conductive particle are easily brought into direct contact with each other, conduction characteristics and uniformity in pushing are estimated to improve. When, as described above, the retaining of the conductive particle by the relatively high viscosity insulating resin is balanced with the above-described lack, decrease, or deformation of the resin right above the conductive particle in the film surface direction, the conditions for capturing the conductive particle, uniformity in pushing, and favorable conduction characteristics come to be met. Also, the relatively high viscosity resin itself (the thickness of the insulating resin layer) can be thinned, which increases design flexibility. For example, a second resin layer having a relatively low viscosity may be laminated. When the relatively high viscosity resin itself is thinned, a margin is easily taken for the heat and pressure condition of a connection tool. In this case, it is desirable that variations in conductive particle diameter be small, which promotes the exertion of the effect. This is because when variations in conductive particle diameter are large, the degree of an inclination or an undulation differs among the conductive particles.

When the insulating resin layer around the conductive particle exposed from the insulating resin layer has an inclination, the insulating resin in the inclined portion is less likely to prevent the conductive particle from being held between terminals or being flatly crushed at the time of anisotropic conductive connection. Also, since the resin amount around the conductive particle is decreased by the inclination, the resin flow, which causes the conductive particle to unnecessarily flow, decreases accordingly. Therefore, the conductive particle capturing properties at terminals improve, and conduction reliability improves.

Also, when the insulating resin layer right above the conductive particle embedded in the insulating resin layer has an undulation, the conductive particle is likely to be subjected to pushing forces from terminals at the time of anisotropic conductive connection, in the same manner as in the inclination. The reasons for this will be described. Since the resin amount right above the conductive particle is decreased by an undulation, the conductive particle is immobilized. In addition, with the undulation, it is estimated that the resin is more likely to flow at the time of connection than when the resin is deposited flatly (see FIG. 8). Thus, the same effects as that in the inclination can also be expected. Therefore, the conductive particle capturing properties at terminals also improve in this case, and conduction reliability improves.

According to such an anisotropic conductive film of the present invention, the conductive particle capturing properties improve, and the conductive particle on a terminal is less likely to flow. Thus, the disposition of the conductive particle can be precisely controlled. Therefore, for example, the anisotropic conductive film according to the present invention can be used for connection with a fine pitch electronic component having a terminal width of 6 μm to 50 μm and a space between terminals of 6 μm to 50 μm. Also, when the size of the conductive particle is less than 3 μm (for example, 2.5 to 2.8 μm), an electronic component can be connected without causing short circuits if the effective connection terminal width (a width of an overlapped portion in a plan view of a pair of facing terminals at the time of connection) is 3 μm or more, and the shortest distance between terminals is 3 μm or more.

Since the disposition of the conductive particles can be precisely controlled, dispersibility (independency of individual conductive particles), disposition regularity, a distance between particles, and the like can be adapted to various terminal layouts of electronic components when normal pitch electronic components are connected.

Furthermore, when the insulating resin layer right above the conductive particle embedded in the insulating resin layer has an undulation, the position of the conductive particle can be clearly recognized by external observation of the anisotropic conductive film. Therefore, product testing is facilitated, and a surface to be used, that is, which film surface of the anisotropic conductive film is to be bonded to a substrate at the time of anisotropic conductive connection, can be easily recognized.

In addition, according to the anisotropic conductive film of the present invention, the photo-polymerizable insulating resin layer is not necessarily previously photo-polymerized for immobilizing the disposition of the conductive particles. Therefore, the insulating resin layer can have tack properties at the time of anisotropic conductive connection. This improves workability both when temporarily pressure-bonding the anisotropic conductive film and a substrate and when pressure-bonding an electronic component after the temporary pressure-bonding.

Meanwhile, according to the producing method of the anisotropic conductive film of the present invention, the viscosity of the insulating resin layer, the pushing speed, the temperature, and the like when the conductive particles are embedded into the insulating resin layer are adjusted such that the insulating resin layer has the above-described inclination or undulation. Thus, the anisotropic conductive film according to the present invention which exerts the above-described effects can be easily produced.

Also, the insulating resin layer constituting the anisotropic conductive film according to the present invention is constituted by the photo-polymerizable resin composition. Therefore, when a connection structure is produced by bonding electronic components with each other by anisotropic conductive connection with the anisotropic conductive film according to the present invention, the photo-polymerizable insulating resin layer of the anisotropic conductive film is irradiated with light after the anisotropic conductive film has been disposed to one of the electronic components and before the other electronic component is disposed on the one electronic component. Therefore, the minimum melt viscosity of the insulating resin can be prevented from excessively decreasing at the time of anisotropic conductive connection, thereby preventing the conductive particles from unnecessarily flowing. As a result, the connection structure has favorable conduction characteristics.

### BRIEF DESCRIPTION OF DRAWINGS

FIG. 1A is a plan view illustrating a disposition of conductive particles of an anisotropic conductive film 10A according to an example.

FIG. 1B is a cross-sectional view of the anisotropic conductive film 10A according to the example.

FIG. 2 is a cross-sectional view of an anisotropic conductive film 10B according to an example.

FIG. 3 is a cross-sectional view of an anisotropic conductive film 10C in a state between an “inclination” and an “undulation” to be formed in an insulating resin layer.

FIG. 4 is a cross-sectional view of an anisotropic conductive film 10D according to an example.

FIG. 5 is a cross-sectional view of an anisotropic conductive film 10E according to an example.

FIG. 6 is a cross-sectional view of an anisotropic conductive film 10F according to an example.

FIG. 7 is a cross-sectional view of an anisotropic conductive film 10G according to an example.

FIG. 8 is a cross-sectional view of an anisotropic conductive film 10X according to a comparative example.

FIG. 9 is a cross-sectional view of an anisotropic conductive film 10H according to an example.

FIG. 10 is a cross-sectional view of an anisotropic conductive film 10I according to an example.

### DESCRIPTION OF EMBODIMENTS

Hereinafter, the anisotropic conductive film of the present invention will be described in detail with reference to the drawings. It is noted that the same reference numerals indicate the same or equivalent constituents in the drawings.

### <Entire Configuration of Anisotropic Conductive Film>

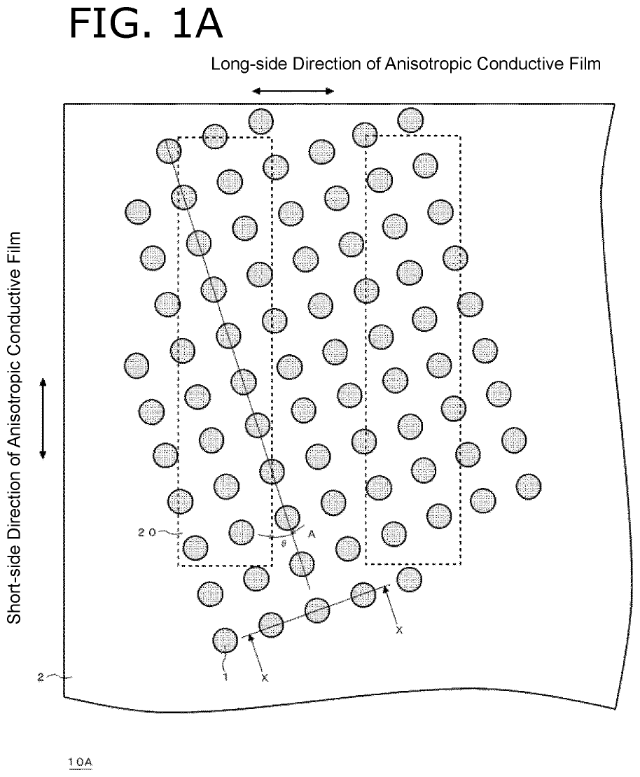

FIG. 1A is a plan view illustrating a particle disposition of an anisotropic conductive film 10A according to an example of the present invention, and FIG. 1B is an X-X cross-sectional view thereof.

This anisotropic conductive film 10A may be, for example, a long length film having a length of 5 m or more, and also may be a wound body in which a film is wound around a core.

The anisotropic conductive film 10A is constituted by a conductive particle dispersion layer 3. The conductive particle dispersion layer 3 includes conductive particles 1 which are regularly dispersed (or distributed) in a state of being exposed from one surface of a photo-polymerizable insulating resin layer 2. The conductive particles 1 are not in contact with each other in the plan view of the film, and are also regularly dispersed (or distributed) without overlapping with each other in a film thickness direction, thereby to constitute a single-layer conductive particle layer in which the conductive particles 1 are aligned in the position in the film thickness direction.

A surface 2a of the insulating resin layer 2 around each of the conductive particles 1 has an inclination 2b formed with respect to a tangent plane 2p of the insulating resin layer 2 in the center portion between the adjacent conductive particles. In the anisotropic conductive film according to the present invention, the surface of the insulating resin layer right above the conductive particle 1 embedded in the insulating resin layer 2 may have an undulation 2c (FIG. 4 and FIG. 6), as described later.

In the present invention, the “inclination” means a state in which the surface of the insulating resin layer loses flatness in the vicinity of the conductive particle 1, and the resin layer is partly lacked with respect to the tangent plane 2p, resulting in a decreased resin amount. In other words, in the inclination, the surface of the insulating resin layer around the conductive particle is lacked with respect to the tangent plane. Meanwhile, the “undulation” means a state in which the surface of the insulating resin layer right above the conductive particle has a waviness, and the existence of a portion having a difference in height like a waviness reduces the resin amount. In other words, the resin amount of the insulating resin layer right above the conductive particle is smaller than that when the surface of the insulating resin layer right above the conductive particle is flush with the tangent plane. These can be recognized by comparing a portion right above the conductive particle and a flat surface portion (2f in FIGS. 1B, 4, and 6) between the conductive particles. It is noted that the starting point of the undulation may be present as an inclination.

### <Dispersion State of Conductive Particles>

As described herein, the dispersion state of the conductive particles includes both a state in which the conductive particles 1 are randomly dispersed and a state in which the conductive particles 1 are regularly dispersed (or distributed.) In this dispersion state, the conductive particles are preferably disposed without being in contact with each other, and the ratio of the number thereof is preferably 95% or more, more preferably 98% or more, and further preferably 99.5% or more. In the regular disposition under the dispersion state, two or more conductive particles which are in contact with each other (in other words, aggregated conductive particles) are counted as one for the ratio of the number. The ratio of the number thereof can be calculated by the same measurement method as a later-described area occupancy ratio of the conductive particles in a film plan view, with preferably N=200 or more. In either case, the conductive particles are preferably aligned in the position in the film thickness direction in terms of capturing stability. Here, a case where the conductive particles 1 are aligned in the position in the film thickness direction includes not only a case where the conductive particles 1 are aligned at a single depth in the film thickness direction, but also an aspect where the conductive particles are present at respective interfaces of the front and back of the insulating resin layer 2 or in the vicinity of the interfaces.

The conductive particles 1 are preferably regularly arranged in a plan view of the film in terms of balancing between the capturing of the conductive particles and the suppression of short circuits. An aspect of the arrangement is not particularly limited because the arrangement depends on the layout of terminals and bumps. For example, a square lattice arrangement in a plan view of the film can be employed as illustrated in FIG. 1A. As other aspects of the regular arrangement of the conductive particles, may be mentioned a rectangular lattice arrangement, an orthorhombic lattice arrangement, a hexagonal lattice arrangement, and a triangle lattice arrangement. Lattices having different shapes may be combined. The regular arrangement is not limited to the above-described lattice arrangements. For example, particle lines each including the conductive particles spaced apart at a predetermined interval may be aligned in parallel at a predetermined interval. When the conductive particles 1 are not in contact with each other, and are regularly arranged into a lattice shape or the like, pressure can be equally applied onto each of the conductive particles 1 at the time of anisotropic conductive connection. This reduces variations in conduction resistance. A regular arrangement can be confirmed by, for example, observing whether or not a predetermined particle disposition is repeated in a long-side direction of a film.

Furthermore, it is more preferable, for balancing between capturing stability and short circuit suppression, that the conductive particles be regularly arranged in a plan view of a film and be aligned in the position in the film thickness direction.

On the other hand, when a space between terminals of an electronic component to be connected is wide so that short circuits are less likely to occur, the conductive particles may not be regularly arranged and instead may be randomly dispersed as long as there exist conductive particles to such an extent that conduction is not impaired. In this case, it is also preferable that the particles be independent from each other in the same manner as above. This is because testing and management during the production of the anisotropic conductive film are facilitated.

When the conductive particles are regularly arranged, and the arrangement has a lattice axis or an arrangement axis, the axis may be the long-side direction of the anisotropic conductive film or parallel to a direction orthogonal to the long-side direction, or may intersect with the long-side direction of the anisotropic conductive film. The axis can be set depending on the width, pitch, layout, and the like of terminals to be connected. For example, for a fine pitch anisotropic conductive film, a lattice axis A of the conductive particles 1 is set to be oblique to the long-side direction of the anisotropic conductive film 10A, and an angle θ formed between the lattice axis A and a long-side direction of a terminal 20 (a short-side direction of a film) to be connected with the anisotropic conductive film 10A is set to 6° to 84°, preferably 11° to 74°, as illustrated in FIG. 1A.

The distance between the conductive particles 1 is appropriately determined depending on the size of a terminal to be connected with the anisotropic conductive film and a terminal pitch. For example, when the anisotropic conductive film is used for fine pitch COG (Chip On Glass), the closest distance between the particles is set to be preferably 0.5 times or more, more preferably more than 0.7 times the conductive particle diameter D, in terms of the prevention of the occurrence of short circuits. On the other hand, the closest distance between the particles is set to be preferably 4 times or less, more preferably 3 times or less the conductive particle diameter D, in terms of the conductive particles 1 capturing properties.

The area occupancy ratio of the conductive particles is preferably 35% or less, and more preferably 0.3 to 30%. This area occupancy ratio is calculated according to the following formula:

[Number density of conductive particles in plan view]×[average of plan view area of one conductive particle]×100.

Here, as measurement regions for the number density of the conductive particles, it is preferable that a plurality of rectangular regions (preferably five or more regions, and more preferably 10 or more regions) having a side of 100 μm or more be optionally set, and the total area of the measurement regions be 2 mm² or more. The size of each region and the number of regions may be appropriately adjusted depending on the state of the number density. For example, a rectangular region having a side with a length of 30 times the conductive particle diameter D may be set at preferably 10 or more locations, and more preferably 20 or more locations to have a total area of the measurement regions be 2 mm² or more. As an example of a case in which the number density is relatively large in fine pitch use, the “number density of conductive particles in a plan view” in the above-described formula can be obtained by measuring the number densities of 200 regions (2 mm²) each having an area of 100 μm×100 μm optionally selected from the anisotropic conductive film 10A using an observation image with a metallurgical microscope or the like, and calculating an average of the measured values. The region having an area of 100 μm×100 μm corresponds to a region where one or more bumps exist in a connection object having a space between bumps of 50 μm or less.

Although the value of the number density is not particularly limited as long as the area occupancy ratio is within the above-described range, the number density is preferably 150 to 70000 particles/mm² for practical purposes. In particular, in fine pitch use, the number density is preferably 6000 to 42000 particles/mm², more preferably 10000 to 40000 particles/mm², and further more preferably 15000 to 35000 particles/mm². It is noted that the present invention does not exclude an aspect in which the number density is less than 150 particles/mm².

The number density of the conductive particles may also be obtained by measuring an observation image using an image analysis software (for example, WinROOF, Mitani Corporation) as well as by the observation with a metallurgical microscope as described above. The observing method and the measuring method are not limited to the above-described methods.

Also, an average of a plan view area of one conductive particle is obtained by measuring an observation image of a film surface with an electron microscope such as a metallurgical microscope and a SEM. An image analysis software may be used. The observing method and the measuring method are not limited to the above-described methods.

The area occupancy ratio serves as an index of the thrust required for a pressing jig for pressure-bonding (preferably thermal pressure-bonding) the anisotropic conductive film to an electronic component. In the past, an anisotropic conductive film has been tailored to a fine pitch by narrowing a distance between conductive particles within such a range that short circuits do not occur to increase the number density. However, when the number density is increased in such a manner, a problem could be raised in that the number of terminals of an electronic component increases, and the total connection area of one electronic component increases. This accordingly increases the thrust required for a pressing jig for pressure-bonding (preferably thermal pressure-bonding) the anisotropic conductive film to an electronic component, with the result that pressing is insufficient with a known pressing jig. In contrast to this, when the area occupancy ratio is preferably 35% or less, and more preferably 0.3 to 30% as described above, the thrust required of a pressing jig for thermal pressure-bonding the anisotropic conductive film to an electronic component can be suppressed to be low.

### <Conductive Particles>

The conductive particles 1 to be used can be appropriately selected from conductive particles used in any known anisotropic conductive film. Examples of such conductive particles may include metal particles such as nickel, cobalt, silver, copper, gold, and palladium, alloy particles such as solder, and metal-coated resin particles. Two or more kinds of these may be combined. Among these, metal-coated resin particles are preferable, because the resin particles repel after connection so that they are likely to maintain their contact with a terminal, and thus conduction performance is stabilized. It is noted that the surfaces of the conductive particles may be subjected to an insulation treatment, which does not impair conduction performance, by a known technique.

The conductive particle diameter D is preferably 1 μm or more and 30 μm or less, more preferably 2.5 μm or more and 9 μm or less, in order to adapt to variations in wiring height and suppress the increase of conduction resistance and the occurrence of short circuits. For some connection objects, the diameter D can be suitably more than 9 μm. The particle diameter of the conductive particles before dispersed (or distributed) in the insulating resin layer can be measured with a general purpose particle size distribution measuring device, and the average particle diameter can also be calculated with a particle size distribution measuring device. The measuring device may be either image-type or laser-type. An example of the image-type measuring device may include an FPIA-3000 wet flow-type particle diameter and shape analyzer (Malvern Panalytical Ltd.). The number of samples (the number of conductive particles) to be measured for the conductive particle diameter D is preferably 1000 or more. The conductive particle diameter D in the anisotropic conductive film can be obtained by the observation with an electron microscope such as a SEM. In this case, the number of samples (the number of conductive particles) to be measured for the conductive particle diameter D is desirably 200 or more.

Variations in the particle diameter of conductive particles constituting the anisotropic conductive film according to the present invention is preferably 20% or less in terms of the CV value (standard deviation/average). When the CV value is 20% or less, particles are easy to be equally pressed when held. Particularly when the conductive particles are arranged, pressing force can be prevented from locally concentrating, which contributes to conduction stability. Furthermore, a connection state can be precisely evaluated by dents after connection. Furthermore, light irradiation is uniformized among individual conductive particles, which uniformizes the photo-polymerization of the insulating resin layer. Specifically, a connection state can be precisely checked by dents both when a terminal size is large (such as FOG) and when small (such as COG). This facilitates testing after anisotropic conductive connection, and is expected to improve productivity in a connection step.

Here, variations in particle diameter can be calculated by an image-type particle size distribution measuring device or the like. The conductive particle diameter of the raw material particles of the anisotropic conductive film, which are not disposed in the anisotropic conductive film, can be obtained using, as an example, an FPIA-3000 wet flow-type particle diameter and shape analyzer (Malvern Panalytical Ltd.). In this case, when the number of measured conductive particles is preferably 1000 or more, more preferably 3000 or more, and particularly preferably 5000 or more, variations of the conductive particles in isolation can be accurately grasped. When the conductive particles are disposed in the anisotropic conductive film, the particle diameter can be obtained by a plane image or a cross-sectional image in the same manner as the below-described sphericity.

Conductive particles constituting the anisotropic conductive film according to the present invention are preferably substantially truly spherical. For example, when an anisotropic conductive film including arranged conductive particles is produced using a transfer mold as described in Japanese Patent Application Laid-Open No. 2014-60150, the conductive particles having a substantially truly spherical shape smoothly roll on the transfer mold. Therefore, the conductive particles can be filled into predetermined positions on the transfer mold with high precision. Thus, the conductive particles can be precisely disposed.

Here, “substantially truly spherical” means that a sphericity calculated according to the following formula is 70 to 100.

Sphericity={1−(So−Si)/So}×100

In the above-described formula, So is an area of a circumscribed circle of a conductive particle in a plane image of the conductive particle, and Si is an area of an inscribed circle of a conductive particle in a plane image of the conductive particle.

In this calculation method, the above-described So and Si are preferably obtained by taking a plane image of conductive particles in a plan view and a cross section of the anisotropic conductive film, measuring areas of a circumscribed circle and an inscribed circle for each of optionally selected 100 or more (preferably 200 or more) conductive particles in each of the plane images, and calculating average values for the measured circumscribed circle areas and inscribed circle areas. Also, the sphericity is preferably within the above-described range both in a plan view and a cross section. A difference in sphericity between a plan view and a cross section is preferably within 20, and more preferably within 10. A difference in sphericity is preferably small, because testing at the production of the anisotropic conductive film is mainly performed in a plan view, and detailed quality determination after anisotropic conductive connection is performed in both a plan view and a cross section. For conductive particles in isolation, this sphericity can also be obtained using the above-described FPIA-3000 wet flow-type particle diameter and shape analyzer (Malvern Panalytical Ltd.). When the conductive particles are disposed in the anisotropic conductive film, sphericity can be obtained by a plane image or a cross-sectional image of the anisotropic conductive film in the same manner as sphericity.

### <Photo-Polymerizable Insulating Resin Layer>

### (Viscosity of Photo-Polymerizable Insulating Resin Layer)

The minimum melt viscosity of the insulating resin layer 2 is not particularly limited, and can be appropriately set depending on a target object to be applied with the anisotropic conductive film and a producing method of the anisotropic conductive film. For example, the minimum melt viscosity can be about 1000 Pa·s in a certain producing method of the anisotropic conductive film, as long as the above-described concaves 2b and 2c can be formed. On the other hand, when the anisotropic conductive film is produced by a producing method of retaining conductive particles in a prescribed disposition on a surface of an insulating resin layer, and pushing the conductive particles into the insulating resin layer, the minimum melt viscosity of the resin is preferably 1100 Pa·s or more for enabling film formation of the insulating resin layer.

Also, from the viewpoints of forming the concave 2b around the exposed portion of the conductive particle 1 pushed into the insulating resin layer 2 as illustrated in FIG. 1B, and forming the concave 2c right above the conductive particle 1 pushed into the insulating resin layer 2 as illustrated in FIG. 6, as will be described later in the producing method of the anisotropic conductive film, the minimum melt viscosity is preferably 1500 Pa·s or more, more preferably 2000 Pa·s or more, further preferably 3000 to 15000 Pa·s, and further more preferably 3000 to 10000 Pa·s. This minimum melt viscosity can be obtained by, as an example, using a rotational rheometer (manufactured by TA Instruments, Inc.), maintaining the measurement pressure at 5 g constantly, and utilizing a measurement plate having a diameter of 8 mm. More specifically, the minimum melt viscosity can be obtained under the conditions of a temperature range of 30 to 200° C., a temperature increasing rate of 10° C./min, a measurement frequency of 10 Hz, and a load fluctuation to a measurement plate of 5 g.

When the minimum melt viscosity of the insulating resin layer 2 is as high as 1500 Pa·s or more, unnecessary movement of the conductive particles can be suppressed at the time of pressure-bonding of the anisotropic conductive film to a connection object. In particular, the conductive particles, which are to be held between terminals at the time of anisotropic conductive connection, can be prevented from being flowed due to the resin flow.

Also, in a case where the conductive particles 1 are pushed into the insulating resin layer 2 thereby to form the conductive particle dispersion layer 3 of the anisotropic conductive film 10A, the insulating resin layer 2 in pushing each of the conductive particles 1 is formed of a high viscous material such that, when the conductive particle 1 is pushed into the insulating resin layer 2 such that the conductive particle 1 is exposed from the insulating resin layer 2, the insulating resin layer 2 is plastically deformed to form the concave 2b (FIG. 1B) on the insulating resin layer 2 around the conductive particle 1, or a high viscous material such that, when the conductive particle 1 is pushed into the insulating resin layer 2 such that the conductive particle 1 is embedded in the insulating resin layer 2 without being exposed from the insulating resin layer 2, the concave 2c (FIG. 6) is formed on the surface of the insulating resin layer 2 right above the conductive particle 1. Therefore, the lower limit of the viscosity at 60° C. of the insulating resin layer 2 is preferably 3000 Pa·s or more, more preferably 4000 Pa·s or more, and further preferably 4500 Pa·s or more, and the upper limit thereof is preferably 20000 Pa·s or less, more preferably 15000 Pa·s or less, and further preferably 10000 Pa·s or less. The viscosity can be measured in the same measurement method as that for the minimum melt viscosity, and obtained by extracting a value at a temperature of 60° C. It is noted that in the present invention, a case in which a viscosity at 60° C. of less than 3000 Pa·s is not excluded. This is because, since mounting at low temperature is required when connection is performed by light irradiation, the viscosity is desirably as low as possible as long as the conductive particle can be retained.

A specific viscosity of the insulating resin layer 2 when the conductive particle 1 is pushed into the insulating resin layer 2 is dependent on the shape and depth of the concaves 2b and 2c to be formed. The lower limit thereof is preferably 3000 Pa·s or more, more preferably 4000 Pa·s or more, and further preferably 4500 Pa·s or more, and the upper limit thereof is preferably 20000 Pa·s or less, more preferably 15000 Pa·s or less, and further preferably 10000 Pa·s or less. Such a viscosity is obtained at preferably 40 to 80° C., and more preferably 50 to 60° C.

When the concave 2b (FIG. 1B) is formed around the conductive particle 1 exposed from the insulating resin layer 2 as described above, resistance received from the resin due to flattening of the conductive particle 1 caused at the time of pressure-bonding of the anisotropic conductive film to an article is reduced more than when the concave 2b does not exist. Therefore, the conductive particle becomes easy to be held by terminals at the time of anisotropic conductive connection, which improves conduction performance and thus capturing properties.

Also, since the concave 2c (FIG. 6) is formed in the surface of the insulating resin layer 2 right above the embedded conductive particle 1 which is not exposed from the insulating resin layer 2, the pressure at the time of pressure-bonding of the anisotropic conductive film to an article is more likely to concentrate on the conductive particle 1 than when the concave 2c does not exist. Therefore, the conductive particle becomes easy to be held by terminals at the time of anisotropic conductive connection, which improves capturing properties and thus conduction performance.

### (Layer Thickness of Photo-Polymerizable Insulating Resin Layer)

In the anisotropic conductive film according to the present invention, the ratio (La/D) of the layer thickness La of the photo-polymerizable insulating resin layer 2 to the conductive particle diameter D is preferably 0.6 to 10. Here, the conductive particle diameter D means the average particle diameter thereof. When the layer thickness La of the insulating resin layer 2 is too large, the conductive particles tend to be displaced at the time of anisotropic conductive connection, and the conductive particles capturing properties at a terminal deteriorate. This tendency is remarkable when the La/D exceeds 10. Therefore, the La/D is more preferably 8 or less, and still more preferably 6 or less. Conversely, when the layer thickness La of the insulating resin layer 2 is too small and the La/D is less than 0.6, it becomes difficult to retain the conductive particles 1 in a predetermined particle dispersed (or distributed) state or a predetermined arrangement by the insulating resin layer 2. In particular, when the terminals to be connected are high-density COGs, the (La/D) of the thickness La of the insulating resin layer 2 to the conductive particle diameter D is preferably 0.8 to 2.

### (Composition of Photo-Polymerizable Insulating Resin Layer)

The insulating resin layer 2 is formed of a photo-polymerizable resin composition. For example, the insulating resin layer 2 may be formed of a photocationic-polymerizable resin composition, a photoradical-polymerizable resin composition, or a photoanionic-polymerizable resin composition. These photo-polymerizable resin compositions may contain a thermal polymerization initiator as necessary.

### (Photocationic-Polymerizable Resin Composition)

The photocationic-polymerizable resin composition contains a polymer for forming a film, a photocationic-polymerizable compound, a photocationic polymerization initiator, and a thermal cationic polymerization initiator.

### (Polymer for Forming Film)

As the polymer for forming a film, a known polymer for forming a film applied to anisotropic conductive films can be used. Examples thereof may include a bisphenol S-type phenoxy resin, a phenoxy resin having a fluorene skeleton, polystyrene, polyacrylonitrile, polyphenylene sulfide, polytetrafluoroethylene, and polycarbonate. These may be used alone or two or more kinds thereof may be used in combination. Among these, a bisphenol S-type phenoxy resin can be suitably used from the viewpoints of the film formation state, connection reliability, and the like. Phenoxy resins are polyhydroxy polyethers that are synthesized from bisphenols and epichlorohydrin. Specific examples of commercially available phenoxy resins may include a product, of which the trade name is “FA290,” of Shin-Nippon Steel Sumikin Chemical Co., Ltd.

The mixing amount of the polymer for forming a film in the photocationic-polymerizable resin composition is preferably 5 to 70 wt %, more preferably 20 to 60 wt %, of the resin component (total of the polymer for forming a film, the photo-polymerizable compound, the photo-polymerization initiator, and the thermal polymerization initiator) in order to achieve an appropriate minimum melt viscosity.

### (Photocationic-Polymerizable Compound)

The photocationic-polymerizable compound is at least one selected from an epoxy compound and an oxetane compound.

As the epoxy compound, a compound having 5 or less functions is preferably used. The epoxy compound having 5 or less functions is not particularly limited, and examples thereof may include a glycidyl ether-type epoxy compound, a glycidyl ester-type epoxy compound, an alicyclic epoxy compound, a bisphenol A-type epoxy compound, a bisphenol F-type epoxy compound, a dicyclopentadiene-type epoxy compound, a novolac phenol-type epoxy compound, a biphenyl-type epoxy compound, and a naphthalene-type epoxy compound. One of these may be used alone or two or more kinds thereof may be used in combination.

Specific examples of commercially available glycidyl ether-type monofunctional epoxy compounds may include a product, of which the trade name is “EPOGOSEY EN,” of Yokkaichi Chemical Co., Ltd. Specific examples of commercially available bisphenol A-type bifunctional epoxy compounds may include a product, of which the trade name is “840-S,” of DIC Corporation. Specific examples of commercially available dicyclopentadiene-type pentafunctional epoxy compounds may include a product, of which the trade name is “HP-7200 Series,” of DIC Corporation.

The oxetane compound is not particularly limited, and examples thereof may include a biphenyl-type oxetane compound, a xylylene-type oxetane compound, a silsesquioxane-type oxetane compound, an ether-type oxetane compound, a phenol novolac-type oxetane compound, and a silicate-type oxetane compound. One of these may be used alone or two or more kinds thereof may be used in combination. Specific examples of commercially available biphenyl-type oxetane compounds may include a product, of which the trade name is “OXBP,” of Ube Industries, Ltd.

The content of the cationic-polymerizable compound in the photocationic-polymerizable resin composition is preferably 10 to 70 wt %, more preferably 20 to 50 wt %, of the resin component in order to achieve an appropriate minimum melt viscosity.

### (Photocationic Polymerization Initiator)

As the photocationic polymerization initiator, any known photocationic polymerization initiator may be used, and onium salts having tetrakis(pentafluorophenyl)borate (TFPB) as an anion may preferably be used. This makes it possible to suppress an excessive increase in the minimum melt viscosity after photo-curing. This may be considered to be because the substituent of TFPB is large and the molecular weight is large.

As the cationic moiety of the photocationic polymerization initiator, aromatic oniums such as an aromatic sulfonium, an aromatic iodonium, an aromatic diazonium, an aromatic ammonium and the like may preferably be adopted. Among these, triarylsulfonium, which is an aromatic sulfonium, is preferably adopted. Specific examples of commercially available onium salts containing TFPB as anions may include a product, of which the trade name is “IRGACURE 290,” of BASF Japan Co., Ltd., and a product, of which the trade name is “WPI-124,” of Fujifilm Wako Pure Chemical Corporation.

The content of the photocationic polymerization initiator in the photocationic-polymerizable resin composition is preferably 0.1 to 10 wt %, and more preferably 1 to 5 wt %, in the resin component.

### (Thermo-Cationic Polymerization Initiator)

The thermo-cationic polymerization initiator is not particularly limited, and examples thereof may include an aromatic sulfonium salt, an aromatic iodonium salt, an aromatic diazonium salt, and an aromatic ammonium salt. Among these, it is preferable to use an aromatic sulfonium salt. Specific examples of commercially available aromatic sulfonium salts may include a product, of which the trade name is “SI-60,” of Sanshin Chemical Industry Co., Ltd.

The content of the thermo-cationic polymerization initiator is preferably 1 to 30 wt %, more preferably 5 to 20 wt %, of the resin component.

### (Photoradical-Polymerizable Resin Composition)

The photoradical-polymerizable resin composition contains a polymer for forming a film, a photoradical-polymerizable compound, a photoradical polymerization initiator, and a thermo-radical polymerization initiator.

As the polymer for forming a film, those described in the photocationic-polymerizable resin composition may appropriately be selected and used. The content thereof is also as already described.

As the photoradical-polymerizable compound, conventionally known photoradical-polymerizable (meth)acrylate monomers may be used. For example, monofunctional (meth)acrylate-based monomers and bifunctional or polyfunctional (meth)acrylate-based monomers may be used. The content of the photoradical-polymerizable compound in the photoradical-polymerizable resin composition is preferably 10 to 60% by mass, more preferably 20 to 55% by mass, in the resin component.

Examples of the thermo-radical polymerization initiator may include an organic peroxide and an azo-based compound. In particular, an organic peroxide which does not generate nitrogen, which causes bubbles, may preferably be used. The amount of the thermo-radical polymerization initiator used is preferably 2 to 60 parts by mass, more preferably 5 to 40 parts by mass, relative to 100 parts by mass of the (meth)acrylate compound from the viewpoint of the balance between the curing rate and the product life.

### (Other Components)

In order to adjust the minimum melt viscosity, the photo-polymerizable resin composition such as a photocationic-polymerizable resin composition or a photoradical-polymerizable resin composition may preferably contain an insulating filler such as silica (hereinafter referred to simply as a “filler”). The filler content is preferably 3 to 60 wt %, more preferably 10 to 55 wt %, and even more preferably 20 to 50 wt %, relative to the total amount of the photo-polymerizable resin composition in order to achieve an appropriate minimum melt viscosity. The average particle diameter of the filler is preferably 1 to 500 nm, more preferably 10 to 300 nm, and further preferably 20 to 100 nm.

The photo-polymerizable resin composition may preferably further contain a silane coupling agent in order to improve the adhesiveness at the interface between the anisotropic conductive film and the inorganic material. Examples of the silane coupling agent may include epoxy-based, methacryloxy-based, amino-based, vinyl-based, mercapto-sulfide-based, and ureide-based silane coupling agents. These may be used alone or two or more kinds thereof may be used in combination.

Further, the photo-polymerizable resin composition may further contain a filler other than the aforementioned insulating filler, a softener, an accelerator, an anti-aging agent, a colorant (a pigment and a dye), an organic solvent, and an ion catcher agent.

### (Position of Conductive Particles in Thickness Direction of Insulating Resin Layer)

In the anisotropic conductive film according to the present invention, the conductive particles 1 in the thickness direction of the insulating resin layer 2 may be exposed from the insulating resin layer 2, or may be embedded in the insulating resin layer 2 without being exposed, as described above. However, it is preferable that a ratio (Lb/D) (hereinafter, referred to as an embedded rate) of a distance (hereinafter, referred to as an embedding amount) Lb from the tangent plane 2p in the center portion between the adjacent conductive particles to the deepest portion of the conductive particle to a conductive particle diameter D be 30% or more and 105% or less. It is noted that the conductive particles 1 may penetrate through the insulating resin layer 2 with an embedded rate (Lb/D) of 100%.

When the embedded rate (Lb/D) is not less than 30% and less than 60%, mounting at low temperature and low pressure is facilitated as described above. When the embedded rate (Lb/D) is 60% or more, the insulating resin layer 2 easily maintains the conductive particles 1 in a predetermined particle dispersed (or distributed) state or in a predetermined arrangement. When the embedded rate (Lb/D) is 105% or less, the resin amount of the insulating resin layer, which functions to cause the conductive particles to unnecessarily flow between terminals at the time of anisotropic conductive connection, can be reduced.

It is noted that in the present invention, the value of the embedded rate (Lb/D) indicates that 80% or more, preferably 90% or more, and more preferably 96% or more of all the conductive particles included in the anisotropic conductive film have such a value of the embedded rate (Lb/D). Therefore, a case where the embedded rate is 30% or more and 105% or less means that 80% or more, preferably 90% or more, and more preferably 96% or more of all the conductive particles included in the anisotropic conductive film have an embedded rate of 30% or more and 105% or less. When the embedded rate (Lb/D) is similar among all the conductive particles, pressing weight is uniformly applied on the individual conductive particles. This improves the conductive particle capturing state by terminals, and is expected to stabilize conduction. For further enhancing precision, 200 or more conductive particles may be measured for calculation.

The embedded rate (Lb/D) can be collectively measured and obtained for a certain number of particles by adjusting focus in a plan view image. Alternatively, the embedded rate (Lb/D) may be measured using a laser displacement sensor (manufactured by Keyence Corporation or the like).

(Aspect of Embedded Rate of not Less than 30% and Less than 60%)

A more specific aspect of the conductive particles 1 with an embedded rate (Lb/D) of not less than 30% and less than 60% may be an aspect in which the conductive particles 1 are embedded in such a manner as to be exposed from the insulating resin layer 2 with an embedded rate of not less than 30% and less than 60%, like the anisotropic conductive film 10A illustrated in FIG. 1B. This anisotropic conductive film 10A has the inclination 2b with respect to the tangent plane 2p on the surface 2a of the insulating resin layer in the center portion between the adjacent conductive particles. The inclination 2b is a ridge line in which a portion of the surface of the insulating resin layer 2 being in contact with each of the conductive particles 1 exposed from the insulating resin layer 2 and a vicinity thereof roughly follow the outer shape of the conductive particle.

Such an inclination 2b or a later-described undulation 2c can be formed by pushing the conductive particle 1 at 40 to 80° C. with preferably 3000 to 20000 Pa·s, and more preferably 4500 to 15000 Pa·s, when the anisotropic conductive film 10A is produced by pushing the conductive particle 1 into the insulating resin layer 2.

(Aspect of Embedded Rate of not Less than 60% and Less than 100%)

A more specific aspect of the conductive particles 1 with an embedded rate (Lb/D) of 60% or more and 105% or less may include, in the same manner as the aspect of an embedded rate of not less than 30% and less than 60%, an aspect in which the conductive particles 1 are embedded in such a manner as to be exposed from the insulating resin layer 2 with an embedded rate of not less than 60% and less than 100%, like the anisotropic conductive film 10A illustrated in FIG. 1B. This anisotropic conductive film 10A has the inclination 2b with respect to the tangent plane 2p on the surface 2a of the insulating resin layer in the center portion between the adjacent conductive particles. The inclination 2b is a ridge line in which a portion of the surface of the insulating resin layer 2 being in contact with each of the conductive particles 1 exposed from the insulating resin layer 2 and a vicinity thereof roughly follow the outer shape of the conductive particle.

Such an inclination 2b or a later-described undulation 2c can be formed by pushing the conductive particle 1 at 40 to 80° C. with preferably 3000 to 20000 Pa·s, and more preferably 4500 to 15000 Pa·s, when the anisotropic conductive film 10A is produced by pushing the conductive particle 1 into the insulating resin layer 2. Also, the inclination 2b and the undulation 2c can disappear in some cases, when, for example, the insulating resin layer is heat pressed. When the inclination 2b does not have its trace, it comes to have a shape substantially equivalent to the undulation 2c (that is, an inclination changes into an undulation). When the undulation 2c does not have its trace, the conductive particle can be exposed from the insulating resin layer 2 at one point in some cases.

### (Aspect of Embedded Rate of 100%)

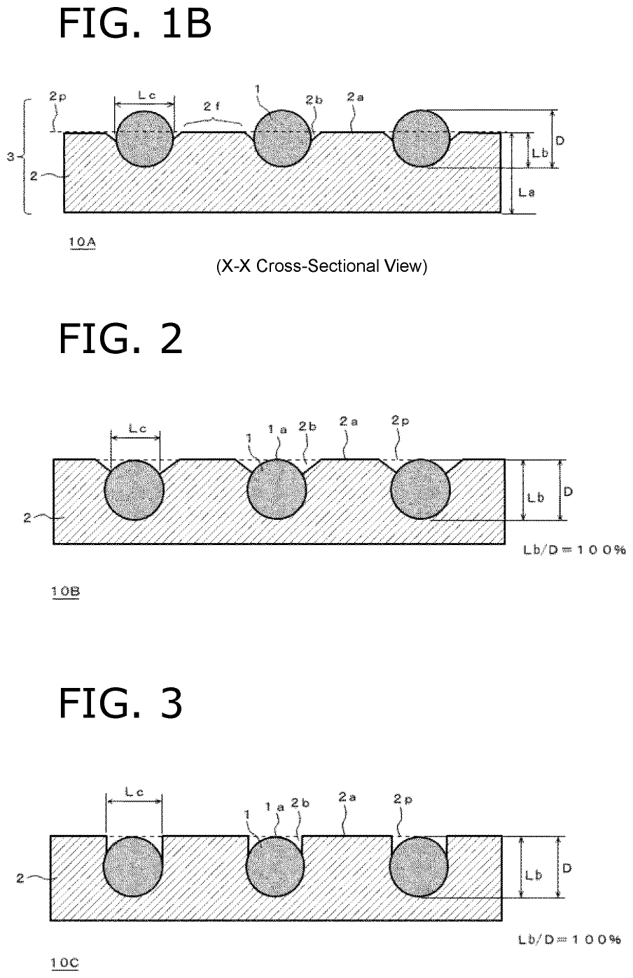

Next, an aspect of the anisotropic conductive film according to the present invention with an embedded rate (Lb/D) of 100% may include: an aspect in which, like an anisotropic conductive film 10B illustrated in FIG. 2, an inclination 2b, which is a ridge line roughly following the outer shape of the conductive particle, exists around the conductive particle 1, in the same manner as the anisotropic conductive film 10A illustrated in FIG. 1B, and an exposure diameter Lc of the conductive particle 1 exposed from the insulating resin layer 2 is smaller than the conductive particle diameter D; an aspect in which, like an anisotropic conductive film 10C illustrated in FIG. 3, an inclination 2b around the exposed portion of the conductive particle 1 abruptly appears in the vicinity of the conductive particle 1, and the exposure diameter Lc of the conductive particle 1 and the conductive particle diameter D are substantially the same; and an aspect in which, like an anisotropic conductive film 10D illustrated in FIG. 4, the surface of the insulating resin layer 2 contains a shallow undulation 2c, and a top 1a of the conductive particle 1 is exposed at one point from the insulating resin layer 2.

Since these anisotropic conductive films 10B, 10C, and 10D have an embedded rate of 100%, the top 1a of the conductive particle 1 and the surface 2a of the insulating resin layer 2 are flush with each other. When the top 1a of the conductive particle 1 and the surface 2a of the insulating resin layer 2 are flush with each other, an effect is produced in that the resin amount in a film thickness direction around each of the conductive particles at the time of anisotropic conductive connection is less likely to become non-uniform, and the movement of the conductive particle due to the resin flow can be reduced, compared to a case where the conductive particle 1 projects from the insulating resin layer 2 as illustrated in FIG. 1B. It is noted that even if the embedded rate is not strictly 100%, this effect can be obtained when the top of the conductive particle 1 embedded in the insulating resin layer 2 is aligned with the surface of the insulating resin layer 2 to such a degree as to be flush with each other. In other words, when the embedded rate (Lb/D) is about 90 to 100%, the top of the conductive particle 1 embedded in the insulating resin layer 2 is considered to be flush with the surface of the insulating resin layer 2, and thus the movement of the conductive particle due to the resin flow can be reduced.

Among these anisotropic conductive films 10B, 10C, and 10D, the anisotropic conductive film 10D is expected to have an effect in that the resin amount around the conductive particle 1 is less likely to become non-uniform, which can eliminate the movement of the conductive particle due to the resin flow. Furthermore, since the top 1a of the conductive particle 1 is exposed from the insulating resin layer 2 even at one point, it is expected that the capturing properties of the conductive particle 1 at a terminal can be favorable, and even slight movement of the conductive particle is less likely to occur. Therefore, this aspect is effective particularly for a fine pitch or when a space between bumps is narrow.

It is noted that the anisotropic conductive films 10B (FIG. 2), 10C (FIG. 3), and 10D (FIG. 4), which include the inclination 2b or the undulation 2c each having a different shape and depth, can be produced by changing, for example, the viscosity of the insulating resin layer 2 at the time of pushing of the conductive particle 1 as described later. It is noted that the aspect of FIG. 3 can be rephrased as an intermediate state between FIG. 2 (an aspect of the inclination) and FIG. 4 (an aspect of the undulation). The present invention also encompasses this aspect of FIG. 3.

(Aspect of Embedded Rate of More than 100%)

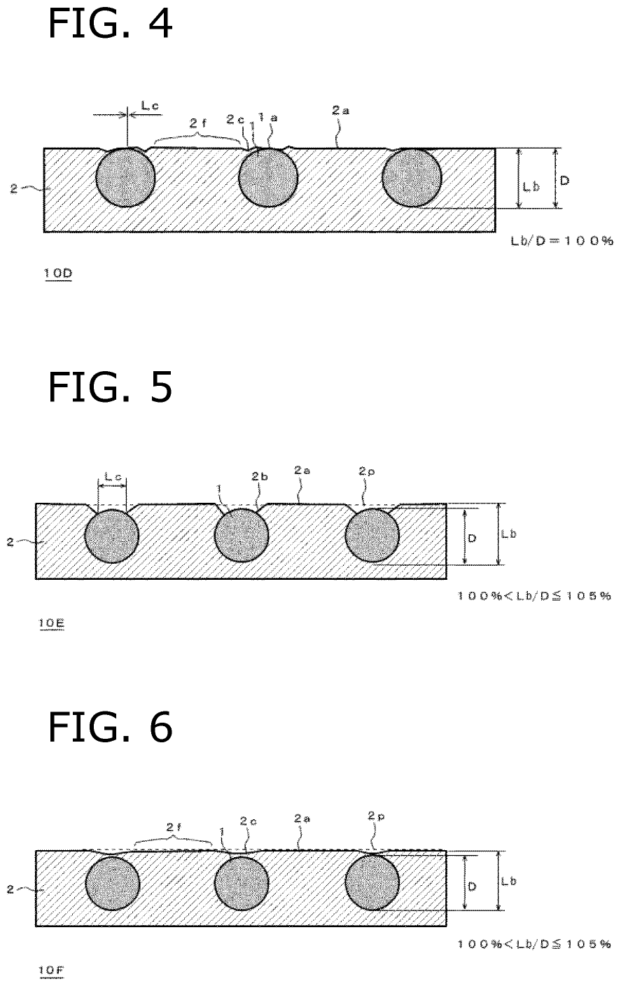

An example of the anisotropic conductive film according to the present invention with an embedded rate of more than 100% may include an aspect in which, like an anisotropic conductive film 10E illustrated in FIG. 5, the conductive particle 1 is exposed, and the insulating resin layer 2 around the exposed portion has the inclination 2b with respect to the tangent plane 2p, or the surface of the insulating resin layer 2 right above the conductive particle 1 has the undulation 2c with respect to the tangent plane 2p.

It is noted that the anisotropic conductive film 10E (FIG. 5) including the inclination 2b in the insulating resin layer 2 around the exposed portion of the conductive particle 1 and an anisotropic conductive film 10F (FIG. 6) including the undulation 2c in the insulating resin layer 2 right above the conductive particle 1 can be produced by changing, for example, the viscosity of the insulating resin layer 2 at the time of pushing of the conductive particle 1 for producing a film.

It is noted that when the anisotropic conductive film 10E illustrated in FIG. 5 is used for anisotropic conductive connection, the conductive particle 1 is directly pressed by a terminal, which improves the conductive particle capturing properties at the terminal. When the anisotropic conductive film 10F illustrated in FIG. 6 is used for anisotropic conductive connection, the conductive particle 1 does not directly press a terminal, and comes to press a terminal through the insulating resin layer 2. Since in such a case, the resin amount in a pressing direction is smaller than the state of FIG. 8 (that is, a state in which the conductive particle 1 is embedded with an embedded rate of more than 100% and not exposed from the insulating resin layer 2, and the surface of the insulating resin layer 2 is flat), pressing force is likely to be applied to the conductive particle, and the conductive particle 1 between terminals is prevented from unnecessarily moving due to the resin flow at the time of anisotropic conductive connection.

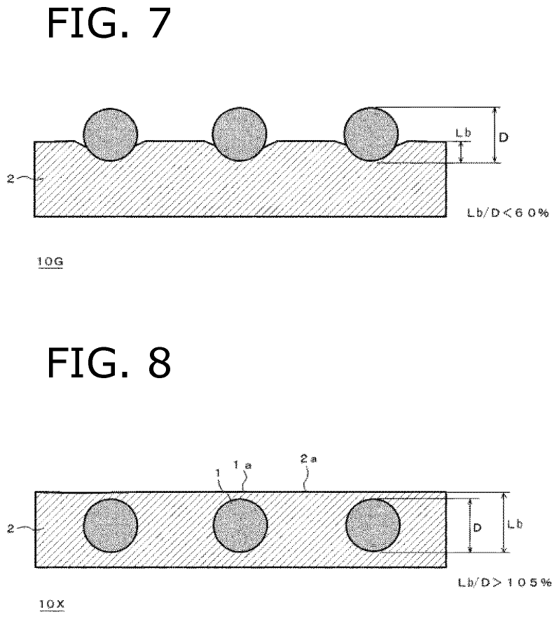

It is noted that with an anisotropic conductive film 10G with an embedded rate (Lb/D) of less than 60%, the conductive particles 1 are easy to roll on the insulating resin layer 2, as illustrated in FIG. 7. Therefore, the embedded rate (Lb/D) is preferably 60% or more in terms of improving the conductive particle capturing rate at the time of anisotropic conductive connection.

When the surface of the insulating resin layer 2 is flat in an aspect with an embedded rate (Lb/D) of more than 100%, like an anisotropic conductive film 10X according to a comparative example illustrated in FIG. 8, a resin amount between the conductive particle 1 and a terminal is excessively large. Furthermore, since the terminal is pressed through the insulating resin layer without being pressed by the conductive particle 1 being in direct contact with the terminal, the conductive particle is also easily flowed due to the resin flow.

In the present invention, the existence of the inclination 2b and undulation 2c on the surface of the insulating resin layer 2 can be checked by observing the cross section of the anisotropic conductive film with a scanning electron microscope, or also by a plane-view observation. The inclination 2b and the undulation 2c can also be observed with an optical microscope or a metallurgical microscope. Also, the sizes of the inclination 2b and the undulation 2c can be checked by, for example, adjusting focus during the observation of an image. The same applies even after the inclination or the undulation is reduced by heat pressing as described above. This is because a trace is sometimes left.

### <Modified Aspects of Anisotropic Conductive Film>

### (Second Insulating Resin Layer)

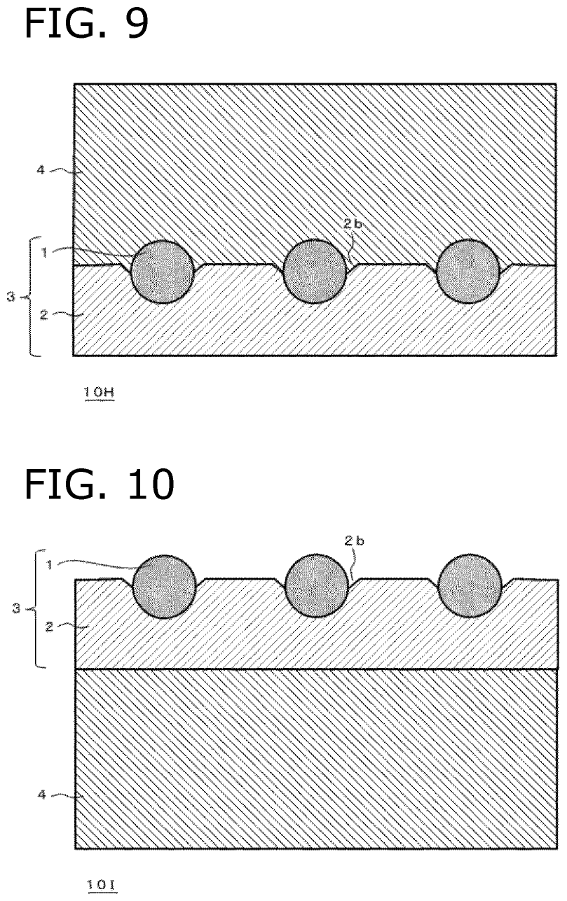

In the anisotropic conductive film according to the present invention, a second insulating resin layer 4, which has a minimum melt viscosity lower than that of the insulating resin layer 2, may be laminated to a surface having the inclination 2b of the insulating resin layer 2 of the conductive particle dispersion layer 3, like an anisotropic conductive film 10H illustrated in FIG. 9. Also, like an anisotropic conductive film 10I illustrated in FIG. 10, the second insulating resin layer 4, which has a minimum melt viscosity lower than that of the insulating resin layer 2, may be laminated to a surface not having the inclination 2b of the insulating resin layer 2 of the conductive particle dispersion layer 3. When the second insulating resin layer 4 is laminated, a space formed by electrodes or bumps of electronic components can be filled when the electronic components are bonded by anisotropic conductive connection with the anisotropic conductive film, thereby to improve adhesiveness. It is noted that, when the second insulating resin layer 4 is laminated, the second insulating resin layer 4 is preferably provided on a side of an electronic component such as an IC chip to be pressurized by a tool (in other words, the insulating resin layer 2 is preferably provided on a side of an electronic component such as a substrate to be placed on a stage), regardless of whether or not the second insulating resin layer 4 is provided on a surface having the inclination 2b. This can prevent unnecessary movement of the conductive particles and improve capturing properties. The same applies when the inclination 2b is the undulation 2c.

The larger the difference in minimum melt viscosity between the insulating resin layer 2 and the second insulating resin layer 4, the more the space formed by electrodes or bumps of electronic components is easily filled with the second insulating resin layer 4. Thus, the effect of improving adhesiveness between electronic components can be expected. The larger the difference thereof, the relatively smaller the movement amount of the insulating resin layer 2 existing in the conductive particle dispersion layer 3. Thus, the conductive particle capturing properties at terminals are likely to improve. For practical purposes, the minimum melt viscosity ratio of the insulating resin layer 2 to the second insulating resin layer 4 is preferably 2 or more, more preferably 5 or more, and further preferably 8 or more. On the other hand, this ratio is preferably 15 or less for practical purposes, because an excessively large ratio can cause squeeze-out of the resin and blocking when a long length anisotropic conductive film is wound into a wound body. More specifically, a preferable minimum melt viscosity of the second insulating resin layer 4 satisfies the above-described ratio, and is also 3000 Pa·s or less, more preferably 2000 Pa·s or less, and particularly preferably 100 to 2000 Pa·s.

It is noted that the second insulating resin layer 4 can be formed by adjusting the viscosity of the same resin composition as the insulating resin layer.

In the anisotropic conductive films 10H and 10I, the layer thickness of the second insulating resin layer 4 is not particularly limited, because it is partly affected by an electronic component or a connection condition. However, the layer thickness is preferably 4 to 20 μm. Alternatively, the layer thickness is preferably 1 to 8 times the conductive particle diameter.

The minimum melt viscosity of the entirety including the combination of the insulating resin layer 2 and the second insulating resin layer 4 of each of the anisotropic conductive films 10H and 10I is preferably more than 100 Pa·s, and more preferably 200 to 4000 Pa·s, because an excessively low minimum melt viscosity may cause squeeze-out of the resin.

(Third insulating resin layer) A third insulating resin layer may be disposed opposite to the second insulating resin layer 4 with the insulating resin layer 2 interposed between the third insulating resin layer and the second insulating resin layer 4. For example, the third insulating resin layer can function as a tack layer. In the same manner as that in the second insulating resin layer, the third insulating resin layer may be disposed in order to fill a space formed by electrodes or bumps of electronic components.

The resin composition, viscosity, and thickness of the third insulating resin layer may be the same as or different from those of the second insulating resin layer. The minimum melt viscosity of the entirety including a combination of the insulating resin layer 2, the second insulating resin layer 4, and the third insulating resin layer of the anisotropic conductive film is not particularly limited, but is preferably more than 100 Pa·s, and more preferably 200 to 4000 Pa·s, because an excessively low minimum melt viscosity may cause squeeze-out of the resin.

### <Producing Method of Anisotropic Conductive Film>

The anisotropic conductive film according to the present invention can be produced by a producing method which includes a step of forming a conductive particle dispersion layer containing conductive particles dispersed (or distributed) in an insulating resin layer.

In this producing method, the step of forming a conductive particle dispersion layer includes: a step of retaining the conductive particles in a state of being dispersed (or distributed) on a surface of the insulating resin layer formed of a photo-polymerizable resin composition; and a step of pushing, into the insulating resin layer, the conductive particles retained on the surface of the insulating resin layer.

In the step of pushing the conductive particles into the surface of the insulating resin layer, the viscosity of the insulating resin layer, the pushing speed, the temperature, or the like at the time of pushing the conductive particles is adjusted such that the surface of the insulating resin layer in the vicinity of each of the conductive particles has an inclination or an undulation with respect to the tangent plane of the insulating resin layer in the center portion between the adjacent conductive particles. Here, the step of pushing the conductive particles into the insulating resin layer is performed such that, in the inclination, the surface of the insulating resin layer around each of the conductive particles is caused to be lacked with respect to the tangent plane, and in the undulation, the resin amount of the insulating resin layer right above the conductive particle is reduced such that it is smaller than that when the surface of the insulating resin layer right above the conductive particle is flush with the tangent plane. Alternatively, the step is performed such that the ratio (Lb/D) of a distance Lb from the tangent plane to the deepest portion of the conductive particle to a conductive particle diameter D is 30% or more and 105% or less. It is noted that the conductive particles and the photo-polymerizable resin composition to be used may be the same as those described for the anisotropic conductive film according to the present invention.

A specific example of the producing method of the anisotropic conductive film according to the present invention may include retaining the conductive particles 1 in a prescribed arrangement on the surface of the insulating resin layer 2, and pushing the conductive particles 1 into the insulating resin layer using a flat plate or a roller. It is noted that the anisotropic conductive film having an embedded rate of more than 100% may be produced by pushing the conductive particles using a push plate having convex portions corresponding to the arrangement of the conductive particles.

Here, the embedding amount of the conductive particles 1 in the insulating resin layer 2 can be adjusted by the pressing force, temperature, or the like at the time of pushing of the conductive particles 1. Also, the shape and depth of the inclination 2b and the undulation 2c can be adjusted by the viscosity of the insulating resin layer 2, the pushing speed, the temperature, or the like at the time of pushing of the conductive particles 1.

A method for retaining the conductive particles 1 in the insulating resin layer 2 can be any known method. For example, the conductive particles 1 are retained in the insulating resin layer 2 by directly spraying the insulating resin layer 2 with the conductive particles 1 or by attaching a single layer of the conductive particles 1 to a biaxially stretchable film, biaxially stretching the film, and pressing the insulating resin layer 2 onto the stretched film to transfer the conductive particles to the insulating resin layer 2. Also, a transfer mold can be used for retaining the conductive particles 1 in the insulating resin layer 2.

When a transfer mold is used to retain the conductive particles 1 in the insulating resin layer 2, examples of such a transfer mold used may include: those having openings formed by a known opening formation method such as a photolithography method applied to inorganic materials such as silicon, various ceramics, glass, and metal such as stainless steel and organic materials such as various resins; and those by applying a printing method. The shape of a transfer mold can be a plate-like shape, a roll-like shape, or the like. It is noted that the present invention is not limited by the above-described methods.

Also, the second insulating resin layer, which is lower in viscosity than the insulating resin layer, can be laminated on the insulating resin layer into which the conductive particles have been pushed, at a surface on a side into which the conductive particles have been pushed or opposite to the surface.

In order to economically connect electronic components with the anisotropic conductive film, the anisotropic conductive film preferably has a certain long length. Therefore, the length of the anisotropic conductive film to be produced is preferably 5 m or more, more preferably 10 m or more, and further preferably 25 m or more. On the other hand, when the anisotropic conductive film is excessively long, a known connecting device, which is used when producing an electronic component with the anisotropic conductive film, cannot be used, and handleability is poor. Therefore, the length of the anisotropic conductive film to be produced is preferably 5000 m or less, more preferably 1000 m or less, and further preferably 500 m or less. Such a long length body of the anisotropic conductive film is preferably a wound body obtained by winding a film around a core, because the wound body is excellent in handleability.

### <Using Method of Anisotropic Conductive Film>

The anisotropic conductive film according to the present invention can be favorably used when a connection structure is produced by bonding a first electronic component such as an IC chip, an IC module, an FPC to a second electronic component such as an FPC, a glass substrate, a plastic substrate, a rigid substrate, and a ceramic substrate by anisotropic conductive connection. The anisotropic conductive film according to the present invention may be used for stacking an IC chip or a wafer to have multiple layers. It is noted that electronic components to be connected with the anisotropic conductive film according to the present invention are not limited to the above-described electronic components. The anisotropic conductive film according to the present invention can be used for various electronic components diversified in recent years. The present invention encompasses: a producing method of a connection structure which includes bonding electronic components by anisotropic conductive connection with the anisotropic conductive film according to the present invention; and the obtained connection structure, that is, a connection structure including electronic components bonded with each other by anisotropic conductive connection with the anisotropic conductive film according to the present invention.

### (Connection Structure and Producing Method of the Same)

The connection structure according to the present invention is obtained by bonding a first electronic component and a second electronic component by anisotropic conductive connection with the anisotropic conductive film according to the present invention. Examples of the first electronic component may include a transparent substrate and a printed circuit board (PWB) for flat panel displays (FPDs) such as a liquid crystal display (LCD) panel and an organic EL (OLED) panel and for touch panels. The material of a printed circuit board is not particularly limited, and examples thereof may include glass epoxy such as an FR-4 base material, plastics such as thermoplastic resin, and ceramics. The transparent substrate is not particularly limited as long as it has high transparency, and examples thereof may include a glass substrate and a plastic substrate. On the other hand, the second electronic component has a second terminal row which faces a first terminal row. The second electronic component is not particularly limited, and can be appropriately selected depending on its intended use. Examples of the second electronic component may include an integrated circuit (IC), a flexible substrate (FPC: Flexible Printed Circuits), a tape carrier package (TCP) substrate, and a chip on film (COF) obtained by mounting an IC to an FPC. It is noted that the connection structure according to the present invention can be produced by a producing method which includes a disposition step, a light irradiation step, and a thermal pressure-bonding step described below.

(Disposition step) First, the anisotropic conductive film is disposed to a first electronic component on a side having an inclination or an undulation of a conductive particle dispersion layer, or on a side not having the inclination or the undulation. When the anisotropic conductive film is disposed on the side having an inclination or an undulation of a conductive particle dispersion layer, photo-irradiation of the inclination or the undulation promotes a reaction in a region having a relatively small resin amount, which is expected to produce an effect of balancing between pushing and retaining of conductive particles. Conversely, when the anisotropic conductive film is disposed to a first electronic component on the side not having an inclination or an undulation of a conductive particle dispersion layer, a region having a relatively large resin amount on the first electronic component side is irradiated with light, resulting in expecting the strengthening of the holding state of the conductive particles. It is noted that in consideration of the light irradiation step, the anisotropic conductive film is preferably disposed on the side having an inclination or an undulation of the conductive particle dispersion layer. This is because the first electronic component and the conductive particles are closer in distance, and thus capturing properties are expected to improve.

### (Light Irradiation Step)

Next, light irradiation (so-called pre-irradiation) is performed to the anisotropic conductive film either on the anisotropic conductive film side or on the first electronic component side, thereby to photo-polymerize the conductive particle dispersion layer. The photo-polymerization facilitates connection at low temperature, and can prevent a to-be-connected electronic component from being excessively heated. When light irradiation is performed on the anisotropic conductive film side, a reaction can be initiated by uniformly irradiating the entire anisotropic conductive film with light before a second electronic component is mounted, which can exclude an influence from a light shielding region (a region related to wiring) that is provided to the first electronic component. Conversely, when light irradiation is performed on the first electronic component side, mounting a second electronic component does not need to be taken into consideration. It is noted that in consideration of the fact that a burden during a connection step is relatively lowering as a connection apparatus develops regarding mounting a second electronic component, light irradiation is preferably performed on the anisotropic conductive film side.

The degree of the photo-polymerization of the conductive particle dispersion layer by light irradiation can be evaluated on the basis of an index called a reaction rate, and is preferably 70% or more, more preferably 80% or more, and further more preferably 90% or more. The upper limit is 100% or less. The reaction rate can be obtained by measuring a resin composition before and after photo-polymerization using a commercially available high performance liquid chromatography apparatus (HPLC, styrene equivalent). The minimum melt viscosity of the conductive particle dispersion layer after light irradiation in this step (that is, the minimum melt viscosity before connection and press out, which can be rephrased as the minimum melt viscosity after the initiation of photo-polymerization) is set such that the lower limit thereof is preferably 1000 Pa·s or more, and more preferably 1200 Pa·s or more, and the upper limit thereof is preferably 8000 Pa·s or less, and more preferably 5000 Pa·s or less, in order to achieve favorable conductive particle capturing properties and favorable pushing of the conductive particles at the time of anisotropic conductive connection. The end-point temperature of this minimum melt viscosity is preferably 60 to 100° C., and more preferably 65 to 85° C.

Irradiation light can be selected from wavelength bands of ultraviolet (UV) light, visible light, infrared (IR) light, or the like, depending on the polymerization properties of the photo-polymerizable anisotropic conductive film. Among these, UV light having high energy (usually, a wavelength of 10 to 400 nm) is preferable.

It is preferable that the anisotropic conductive film be disposed to the first electronic component on a side having an inclination or an undulation of a conductive particle dispersion layer in the disposition step, and light irradiation be performed on the anisotropic conductive film side in the light irradiation step.

### (Thermal Pressure-Bonding Step)

A connection structure can be obtained by disposing a second electronic component to the photo-irradiated anisotropic conductive film, and heating and pressurizing the second electronic component with a known thermal pressure-bonding tool thereby to bond the first electronic component and the second electronic component by anisotropic conductive connection. It is noted that for lowering temperature, the thermal pressure-bonding tool may be used as a pressure-bonding tool without heat. The condition of anisotropic conductive connection can be appropriately set depending on, for example, the electronic components and anisotropic conductive film to be used. It is noted that for thermal pressure-bonding, a cushioning material such as a polytetrafluoroethylene sheet, a polyimide sheet, glass cloth, and silicon rubber may be disposed between a thermal pressure-bonding tool and an electronic component to be connected. It is noted that light irradiation may be performed on the first electronic component side during thermal pressure-bonding.

### INDUSTRIAL APPLICABILITY

The anisotropic conductive film according to the present invention has a conductive particle dispersion layer including conductive particles dispersed (or distributed) in an insulating resin layer formed of a photo-polymerizable resin composition. The surface of the insulating resin layer in the vicinity of each of the conductive particles has an inclination or an undulation with respect to the tangent plane of the insulating resin layer in the center portion between adjacent conductive particles. Therefore, when a connection structure is produced by bonding electronic components by anisotropic conductive connection, the photo-polymerizable insulating resin layer of the anisotropic conductive film is photo-irradiated after the anisotropic conductive film has been disposed to one of the electronic components and before the other electronic component is disposed to the one electronic component, thereby preventing the minimum melt viscosity of the insulating resin at the time of anisotropic conductive connection from excessively decreasing, and the conductive particles from unnecessarily flowing. Thus, the connection structure has favorable conduction characteristics. Thus, the anisotropic conductive film according to the present invention is useful for mounting an electronic component such as a semiconductor device to various substrates.

### REFERENCE SIGNS LIST

1 conductive particle
1a top of conductive particle
2 insulating resin layer
2a surface of insulating resin layer
2b concave (inclination)
2c concave (undulation)
2f flat surface portion
2p tangent plane
3 conductive particle dispersion layer
4 second insulating resin layer
10A, 10B, 10C, 10D, 10E, 10F, 10G, 10H, 10I anisotropic conductive film of example
20 terminal
A lattice axis of arrangement of conductive particles
D conductive particle diameter
La layer thickness of insulating resin layer
Lb embedding amount (distance from tangent plane in center portion between adjacent conductive particles to deepest portion of conductive particle)
Lc exposure diameter
θ angle formed between long-side direction of terminal and lattice axis of arrangement of conductive particles

1. An anisotropic conductive film having a conductive particle dispersion layer including conductive particles dispersed (or distributed) in an insulating resin layer, wherein
the insulating resin layer is a layer of a photo-polymerizable resin composition, and
a surface of the insulating resin layer in a vicinity of each of the conductive particles has an inclination or an undulation with respect to a tangent plane of the insulating resin layer in a center portion between the adjacent conductive particles.

2. The anisotropic conductive film according to claim 1, wherein in the inclination, the surface of the insulating resin layer around each of the conductive particles is lacked with respect to the tangent plane, and in the undulation, a resin amount of the insulating resin layer right above the conductive particle is smaller than that when the surface of the insulating resin layer right above the conductive particle is flush with the tangent plane.

3. The anisotropic conductive film according to claim 1, wherein a ratio (Lb/D) between a distance Lb from the tangent plane to a deepest portion of the conductive particle and a particle diameter D of the conductive particles is 30% or more and 105% or less.

4. The anisotropic conductive film according to claim 1, wherein the photo-polymerizable resin composition is a photocationic-polymerizable resin composition.

5. The anisotropic conductive film according to claim 1, wherein the photo-polymerizable resin composition is a photoradical-polymerizable resin composition.

6. The anisotropic conductive film according to claim 1, wherein the surface of the insulating resin layer around the conductive particle exposed from the insulating resin layer has an inclination or an undulation.

7. The anisotropic conductive film according to claim 1, wherein the surface of the insulating resin layer right above the conductive particle embedded in the insulating resin layer without being exposed from the insulating resin layer has the inclination or the undulation.

8. The anisotropic conductive film according to claim 1, wherein a ratio (La/D) of a layer thickness La of the insulating resin layer to a particle diameter D of the conductive particles is 0.6 to 10.

9. The anisotropic conductive film according to claim 1, wherein the conductive particles are disposed without being in contact with each other.

10. The anisotropic conductive film according to claim 1, wherein a closest distance between the conductive particles is 0.5 times or more and 4 times or less a conductive particle diameter.

11. The anisotropic conductive film according to claim 1, wherein a second insulating resin layer is laminated to a surface opposite to the surface having the inclination or the undulation of the insulating resin layer.

12. The anisotropic conductive film according to claim 1, wherein the second insulating resin layer is laminated to the surface having the inclination or the undulation of the insulating resin layer.

13. The anisotropic conductive film according to claim 11, wherein a minimum melt viscosity of the second insulating resin layer is lower than that of the insulating resin layer.

14. The anisotropic conductive film according to claim 1, wherein a CV value of the particle diameter of the conductive particles is 20% or less.

15. A method of producing the anisotropic conductive film according to claim 1, comprising a step of forming a conductive particle dispersion layer containing conductive particles dispersed (or distributed) in an insulating resin layer, wherein
the step of forming a conductive particle dispersion layer includes: a step of retaining the conductive particles in a state of being dispersed (or distributed) on a surface of an insulating resin layer formed of a photo-polymerizable resin composition; and a step of pushing, into the insulating resin layer, the conductive particles retained on the surface of the insulating resin layer, and
in the step of pushing the conductive particles into the surface of the insulating resin layer, a viscosity of the insulating resin layer, a pushing speed, or a temperature when the conductive particles are pushed is adjusted such that the surface of the insulating resin layer in a vicinity of each of the conductive particles has an inclination or an undulation with respect to a tangent plane of the insulating resin layer in a center portion between the adjacent conductive particles.

16. The method of producing the anisotropic conductive film according to claim 15, wherein in the step of pushing the conductive particles into the insulating resin layer, in the inclination, the surface of the insulating resin layer around each of the conductive particles is lacked with respect to the tangent plane, and in the undulation, a resin amount of the insulating resin layer right above the conductive particle is smaller than that when the surface of the insulating resin layer right above the conductive particle is flush with the tangent plane.

17. The method of producing the anisotropic conductive film according to claim 16, wherein a ratio (Lb/D) of a distance Lb from the tangent plane to a deepest portion of the conductive particle to a conductive particle diameter D is 30% or more and 105% or less.

18. The method of producing the anisotropic conductive film according to claim 15, wherein the photo-polymerizable resin composition is a photocationic-polymerizable resin composition.

19. The method of producing the anisotropic conductive film according to claim 15, wherein the photo-polymerizable resin composition is a photoradical-polymerizable resin composition.

20. The method of producing the anisotropic conductive film according to claim 15, wherein a CV value of the conductive particle diameter is 20% or less.

21. The method of producing the anisotropic conductive film according to claim 15, wherein
the conductive particles are retained in a predetermined arrangement on the surface of the insulating resin layer in the step of retaining the conductive particles on the surface of the insulating resin layer, and
the conductive particles are pushed into the insulating resin layer using a flat plate or a roller in the step of pushing the conductive particles into the insulating resin layer.

22. The method of producing the anisotropic conductive film according to claim 15, wherein, in the step of retaining the conductive particles on the surface of the insulating resin layer, a transfer mold is filled with the conductive particles, and the conductive particles are transferred to the insulating resin layer, thereby to retain the conductive particles in a predetermined arrangement on the surface of the insulating resin layer.

23. A connection structure in which a first electronic component and a second electronic component are bonded by anisotropic conductive connection with the anisotropic conductive film according to claim 1.

24-25. (canceled)

26. A method of producing a connection structure in which a first electronic component and a second electronic component are bonded by anisotropic conductive connection with the anisotropic conductive film according to claim 1.

27. The method of producing a connection structure according to claim 26, wherein the anisotropic conductive connection is performed with light irradiation and a pressure-bonding tool.

28. The method of producing the connection structure according to claim 26, comprising:
an anisotropic conductive film disposition step of disposing the anisotropic conductive film to the first electronic component on a side having the inclination or the undulation of the conductive particle dispersion layer or on a side not having the inclination or the undulation;
a light irradiation step of performing light irradiation on the anisotropic conductive film to photo-polymerize the conductive particle dispersion layer; and
a pressure-bonding step of disposing the second electronic component on the photo-polymerized conductive particle dispersion layer, and pressurizing the second electronic component with a pressure bonding tool to bond the first electronic component and the second electronic component by anisotropic conductive connection.

29. The method of producing a connection structure according to claim 28, wherein
the anisotropic conductive film is disposed to the first electronic component on a side of having the inclination or the undulation of the conductive particle dispersion layer in the disposition step.
